(19) United States
(12) Patent Application Publication
(10) Pub. No.: US 2008/0137255 A1
(43) Pub. Date: Jun. 12, 2008

(54) Current limiting device for electronic controllers or actuators for loads with non-linear current-voltage characteristics

(76) Inventor: Klaus Zametzky, Schwabach (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/974,305

(22) Filed: Oct. 11, 2007

(30) Foreign Application Priority Data
Oct. 13, 2006 (DE) 10 2006 049 080.0

(51) Int. Cl. H02H 9/08

(52) U.S. Cl. 361/93.9

(57) ABSTRACT

An electronic current limiting device is provided in voltage or current controllers for loads with non-linear current-voltage characteristics. Load current is limited depending on load voltage. A current limiting line features non-linear behaviour with at least two different gradients section wise, which are neither zero nor infinite.

The present invention relates to a current limiting device for an electronic controller or actuator that regulates or actuates the current through or the voltage across a load with a non-linear current voltage characteristic, in particular the current limiting device for fan controller in a motor vehicle.

Such devices are generally known. In general, the known devices comprise circuits that regulate the voltage across a load, e.g. an electric motor. Many of these controllers contain a device that limits the maximum possible load or motor current and hence entail a short circuit protection or overload protection. As soon as the motor current I_{Motor} approaches the limit value Iₘₐₓ, then the current limiting device actively limits the motor current in order to keep it below this limit value Iₘₐₓ. Iₘₐₓ is mostly not a constant value, but a variable, which is set time-continuously depending on motor voltage U_{Motor}. The relationship Iₘₐₓ=f (U_{Motor}) is linear for known voltage controllers with current limiting devices for fans, although fan motors generally feature non-linear characteristic I_{Motor}=f (U_{Motor}) with progressively rising function graphs.

From FIG. 2, the inter-connection between motor voltage and motor current (the load characteristic of the motor) as well as the inter-connection between motor voltage and maximum current limit of a known voltage controller with current limit is apparent. The thin, dotted characteristic 2 shows this inter-connection I_{Motor}=f (U_{Motor}). It is apparent that the motor characteristic 2 features a non-linear shape.

Known voltage controllers with current limiting devices lead to linear current limit depending on motor voltage. Voltage controllers with current limiting devices feature a circuit that accounts for motor voltage, and depending on this, it sets the value Iₘₐₓ for the current limit. This limit value is designated in FIG. 2 by means of the black, thick line 3. For 0-1 V motor voltage, the limit value for the motor current is 5 A. Thus, for 0V of motor voltage, a certain amount of current must be permissible or the motor will not start. The maximum permissible motor current is 35 A. This is in characteristic 3 for the current limit assigned to a motor voltage U_{Motor}>12V. The current limit allows a maximum current of 35 A only if the motor voltage is at least 12V. In any case, the characteristic 3 of the current limit may not intersect the motor characteristic 2 within the range 0V<U_{Motor}<12V, since the voltage control with a current limiting device would then limit the motor voltage to values under 12V, and the desired motor power in the case of a fan controller, the desired fan power, would not be at disposal. To guarantee this via the series, characteristic 3 for the current limit Iₘₐₓ=f (U_{Motor}) must observe a certain distance from the motor characteristic 2, which also accounts for tolerances. The distance, however, should only be as large as necessary in order to keep dissipated power as low as possible in a voltage controller with a current limiting device working according to the linear principle, in the event the current limiter responds. If a fan controller were operated with a linear current limit 3 according to FIG. 2 with supply voltage of 14V (this is the normal on-board voltage of a passenger car) and a motor voltage of 7V sets in, then in case of overload, for instance, a ponderous motor operation, the current limiter would limit the load current to 22 A. The dissipated power in a controller working according to the linear principle in this operational case is 7V×22 A=154 W.

### SUMMARY OF THE INVENTION

The task of the invention is to provide a current limiting device with improved adaptation of current limit to the motor characteristic.

This task is solved by means of a current limiting device for an electronic controller or an actuator of the type mentioned at the beginning, in which the current limiting line features a non-linear behaviour with at least two different gradients section-wise, which are neither zero nor infinite as shown in FIG. 1.

In a simple technical implementation, the approximation can be designed through several straight lines connected together. An approximation of the current limiting characteristic line to the current limiting line is realised through a series of straight lines with break points. By this means, a control system with current limit is obtained, which supplies the nominal current of load motor, however, in the event of fault, it limits the current to lower, uncritical values than conventional current limiters. This has the advantage that both the motor as well as the controlling device are safe. The invention is particularly suitable for fan controllers in motor vehicles.

### BRIEF DESCRIPTION OF THE DRAWINGS

A preferred exemplary embodiment of the invention is schematically depicted in the drawing and is explained in detail using the drawing.

FIG. 1 shows the characteristic line function of a current limiter according to the present invention, by considering the current limiting line (motor characteristic); and

FIG. 2 show the characteristic line function of a current limiter according to the state of the art.

### DETAILED DESCRIPTION

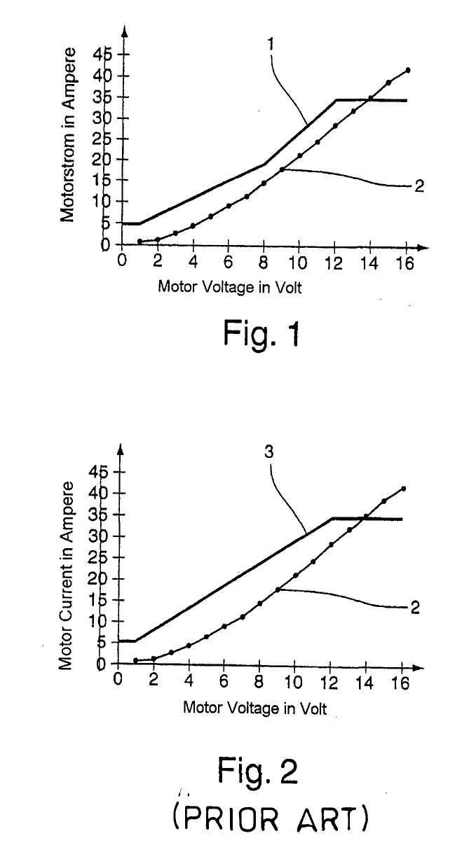

As shown in FIG. 1, the inter-connection between motor voltage and motor current is apparent. The thin, dotted characteristic 2 in FIG. 1 is also shown in FIG. 2, the inter-connection I_{Motor}=f (U_{Motor}). It is apparent that motor characteristic 2 features a non-linear shape. FIG. 1 shows the motor characteristic 2 as well as a likewise non-linear current limiting characteristic line 1. The approximation here occurs through two straight lines of different gradients with a break point at U_{Motor}=8V.

A current limiting device for an electronic controller, which features a current limiting characteristic line 1 according to FIG. 1, for instance, limits the current through a ponderous motor to 17 A for a nominal voltage of 7V. For supply voltage of 14V, dissipated power of 119 W is obtained on an electronic controller working according to the linear principle. In comparison to this, the current limiting device according to FIG. 2 limits the motor current in this example to 22 A and the electronic controller has therefore a dissipated power of 154 W. One realises that non-linear current limiter according to FIG. 1 offers better protection than the linear one according to FIG. 2. The advantage that adjusts when using a non-linear current limiting curve 1 grows with the degree of curvature of the motor characteristic 2.

What is claimed is:

1. In a voltage or current controller for electrical loads with non-linear current-voltage characteristics, an electronic device for limiting current, the limited current being defined by a current limiting characteristic line having non-linear behaviour with at least two different gradient sections each line section being neither zero nor infinite in slope.

2. The device according to claim 1 wherein a design of the current limiting characteristic line is approximated to a non-linear shape of the load characteristic.

3. The device according to claim 1 wherein current limiting characteristic line is shifted against the load characteristic in such a manner that the voltage controller delivers the nominal current of the load even under the consideration of all switching tolerances in all voltage ranges.

4. The device according to claim 1 wherein the current limiting characteristic line is approximated through several inter-connected straight lines.
